(19) United States
(12) Patent Application Publication
(10) Pub. No.: US 2021/0001784 A1
(43) Pub. Date: Jan. 7, 2021

(54) VEHICULAR WINDSHIELD-MOUNTED CAMERA WITH HEAT DISSIPATING GLARE SHIELD

(71) Applicant: Magna Mirrors of America, Inc., Holland, MI (US)

(72) Inventor: Hamid Habibi, Holland, MI (US)

(21) Appl. No.: 16/946,726

(22) Filed: Jul. 2, 2020

Related U.S. Application Data
(60) Provisional application No. 62/882,622, filed on Aug. 5, 2019.
(60) Provisional application No. 62/870,104, filed on Jul. 3, 2019.

(51) Int. Cl. B60R 11/04; B60R 1/04; G03B 17/55

(52) U.S. Cl. CPC B60R 11/04; B60R 2001/1253; G03B 17/55; B60R 1/04

(57) ABSTRACT

A vehicular camera module configured to be disposed at an in-cabin side of a windshield of a vehicle includes a housing and a camera disposed at the housing. The camera includes a lens barrel and an imager. The housing houses a primary circuit board having a processor for processing image data captured by the camera. A glare shield is disposed at the housing and below and forward of the lens of the camera. The glare shield, with the vehicular camera module disposed at the in-cabin side of the windshield, reduces stray light incident at the lens of the camera. The glare shield includes a heat dissipating feature at a lower surface of the glare shield opposite an upper surface that faces the vehicle windshield when the vehicular camera module is disposed at the in-cabin side of the windshield.

### CROSS REFERENCE TO RELATED APPLICATIONS

The present application claims the filing benefits of U.S. provisional application Ser. No. 62/882,622, filed Aug. 5, 2019, and U.S. provisional application Ser. No. 62/870,104, filed Jul. 3, 2019, which are hereby incorporated herein by reference in their entireties.

### FIELD OF THE INVENTION

The present invention relates generally to a vehicular vision system and, more particularly, to a vehicular vision system that utilizes a forward viewing windshield-mounted camera.

### BACKGROUND OF THE INVENTION

Use of imaging sensors in vehicle imaging systems is common and known. Examples of such known systems, with forward viewing cameras mounted at and behind the vehicle windshield, are described in U.S. Pat. Nos. 9,871,971 and/or 9,596,387, which are hereby incorporated herein by reference in their entireties.

### SUMMARY OF THE INVENTION

The present invention provides a driver assistance system or vision system or imaging system for a vehicle that utilizes a windshield-mounted camera to capture image data representative of images exterior and forward of the vehicle. The camera comprises a lens and an imager having a two dimensional array of photosensing elements. The camera module includes a stray light shield or glare shield disposed below and in front of the imager and lens. The stray light shield or glare shield includes a heat dissipating feature at its underside to enhance cooling of the glare shield to reduce the temperature of the glare shield and thus to reduce outgassing of the glare shield when the camera module is exposed to extreme temperatures, such as when a vehicle equipped with the windshield-mounted camera module is parked in the sun on a hot sunny day.

The windshield-mounted camera module of the present invention thus provides a heat dissipating glare shield for reducing the temperature of the glare shield and thus reducing outgassing of the plastic glare shield when the camera module is exposed to extreme temperatures. The heat dissipating feature may comprise a plurality of fins or ribs extending from an undersurface of the glare shield to provide greater surface area for cooling the glare shield. Optionally, airflow at the heat sink may be enhanced (such as via a fan or blower or the like) to enhance the heat dissipation and cooling of the glare shield.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a vision system that incorporates a windshield-mounted camera in accordance with the present invention;

FIG. 2 is an enlarged perspective view through the windshield of a windshield-mounted camera;

FIG. 3 is a sectional view of the windshield and windshield-mounted camera of FIG. 2;

FIG. 4 is a sectional view schematic of a windshield-mounted camera; and

FIG. 5 is an enlarged sectional view schematic of a windshield-mounted camera having a heat dissipating function at the glare shield.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

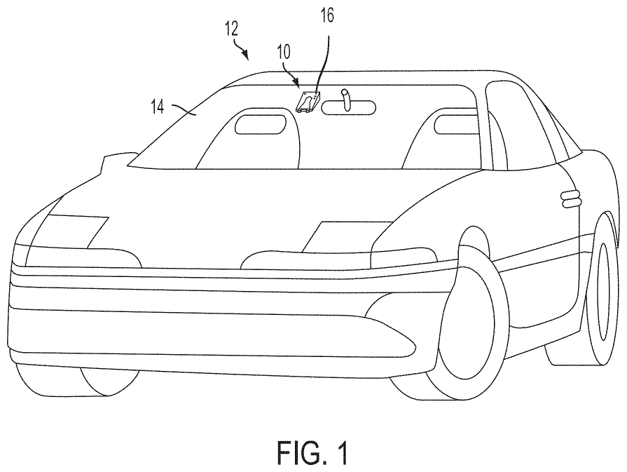

Referring now to the drawings and the illustrative embodiments depicted therein, vision system 10 for a vehicle 12 includes at least one exterior viewing imaging sensor or camera, such as a forward viewing imaging sensor or camera, which may be disposed at and behind the windshield 14 of the vehicle and viewing forward through the windshield so as to capture image data representative of the scene occurring forward of the vehicle (FIG. 1). Optionally, the system may include multiple exterior viewing imaging sensors or cameras, such as a forward viewing camera at the front of the vehicle, and a sideward/rearward viewing camera at respective sides of the vehicle, and a rearward viewing camera at the rear of the vehicle, which capture images exterior of the vehicle. The camera or cameras each include a lens for focusing images at or onto an imaging array or imaging plane or imager of the camera.

As shown in FIG. 1, a windshield-mounted camera module 16 includes a forward viewing camera 18 that, with the camera module 16 disposed at the windshield of the vehicle, views through the windshield and forward of the vehicle, such as for a machine vision system (such as for traffic sign recognition, headlamp control, pedestrian detection, collision avoidance, lane marker detection and/or the like). The vision system 10 includes a control or electronic control unit (ECU) or processor that is operable to process image data captured by the camera or cameras and may detect objects or the like and/or provide displayed images at a display device for viewing by the driver of the vehicle. The data transfer or signal communication from the camera to the ECU may comprise any suitable data or communication link, such as a vehicle network bus or the like of the equipped vehicle.

The camera module 16 and forward viewing camera 18 is installed in the upper center of the vehicle windshield. From this vantage point, the camera captures image data representative of the view through the windshield and in front of the vehicle. The image data captured by the camera is then processed by intelligent algorithms for object detection, such as for detecting vehicles, pedestrians, road markings, traffic signs and other such information of interest ahead of the vehicle and/or in the field of view of the camera. Some camera systems have a very wide field of view (utilizing a wide angle lens or fisheye lens), and the image data captured by such a camera is distorted by the properties of the wide angle lens. This distortion effect is commonly known as the fish-eye lens effect.

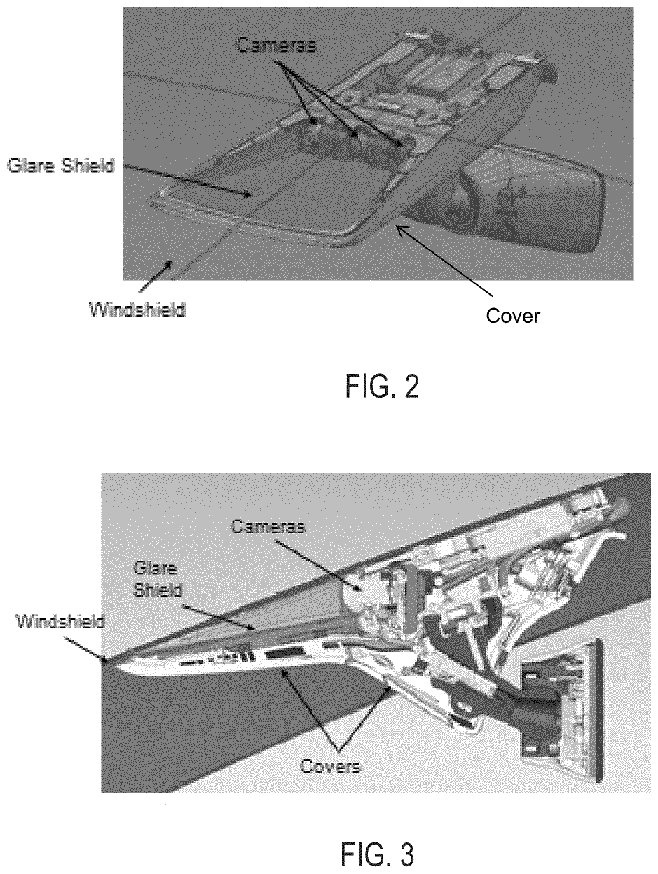

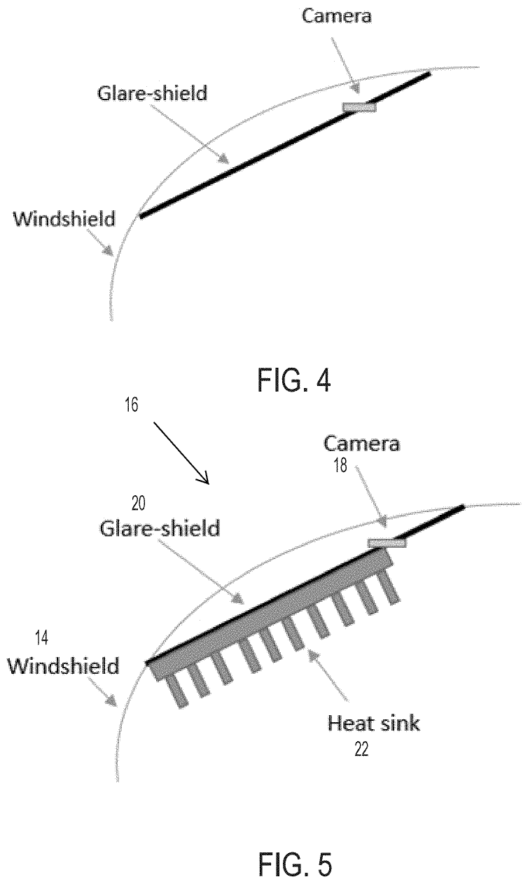

As shown in FIGS. 2-4, the windshield-mounted camera module may include one camera or may include multiple individual cameras (each having its respective imager printed circuit board, imager and lens) disposed at the camera module housing so as to view forward through the windshield of the vehicle. In the illustrated embodiment, the module has three forward viewing cameras disposed at the housing, with a glare shield or stray light shield disposed at the forward part of the housing forward of and below the cameras. Optionally, the camera module may have a single forward viewing camera or two forward viewing cameras or more, depending on the particular application of the camera module. Each camera module may capture image data for a different vehicular function (e.g., an infrared sensing night vision camera and a color video camera) and/or may have two cameras that provide stereo imaging to enhance object detection and distance determination to objects present in the fields of view of the cameras. The camera system or camera module of the present invention may utilize aspects of the systems and/or modules described in U.S. Pat. Nos. 9,896,039; 9,871,971; 9,596,387; 9,451,138; 8,256,821; 7,480,149; 7,289,037; 7,004,593; 6,824,281; 6,690,268; 6,445,287; 6,428,172; 6,420,975; 6,396,397; 6,326,613; 6,278,377; 6,243,003; 6,250,148; 6,172,613 and/or 6,087,953, and/or U.S. Publication Nos. US-2017-0113613 and/or US-2016-0119527, and/or PCT Application No. PCT/US2020/015306, filed Jan. 28, 2020 (Attorney Docket MAG04 FP3765WO), which are all hereby incorporated herein by reference in their entireties.

When installed at a vehicle and exposed to extreme temperatures (such as when the vehicle is parked on a hot sunny summer day and/or when the processor or processors of the camera module are operating for extensive periods of time, thereby generating heat at the underside of or below the glare shield), the glare shield may outgas, which may cause fogging of the windshield in the area through where the cameras view. The glare shield may be formed of a thermoplastic material, such as a PC-ABS (polycarbonate-Acrylonitrile Butadiene Styrene) substrate followed with a TPE (thermoplastic elastomer) followed by an adhesive to hold the black flock fibers. The black flock fibers give a very low reflection property to the glare shield, which is why they are used in making or forming or injection molding the plastic glare shield. Alternatively, the glare shield may be formed of a thermally conductive material, such as a metallic material or a thermally conductive plastic or polymeric material or the like, such as a thermally conductive polyphenylene sulfide (PPS), such as a COOLPOLY® E5101 Thermally Conductive Polyphenylene Sulfide commercially available from Cool Polymers, Inc. of Warwick, R.I. (such as by utilizing aspects of the systems described in U.S. Pat. No. 7,855,755, which is hereby incorporated herein by reference in its entirety).

Fogging at the in-cabin side or surface of the vehicle windshield occurs because the glare shield and/or camera module makes intimate contact with the in-cabin side of the vehicle windshield and there is not much air flow in the region in front of the camera lens, so all the outgassing from various plastic components condense at the windshield surface and create a fog or film or haze, which makes it difficult for the camera(s) to view through the windshield so that the autonomous feature(s) or driving assist feature(s) cannot be engaged.

The glare shield is black to reduce reflection of stray light incident thereon and may also include ribs or undulations or structure to limit the stray light from reflecting toward and being incident at the lens of the camera. Because the glare shield is made up of a thin plastic, it heats up very fast. For example, the black glare shield can get close to 100 degrees C. or even up to 120 degrees C. (or more) when the vehicle is parked in direct sun light. As the glare shield heats up, it outgasses. The fogging at the windshield surface is due to outgassing of various plastic components. Because the windshield is cooler than the black surface of the glare shield, the gases will condense at the in-cabin side or surface of the windshield which causes a haze that makes it difficult for the camera(s) to view through the windshield.

As shown in FIG. 5, the glare shield 20 (disposed in front of and below the camera 18 for reducing glare or incident light at the lens of the camera) includes a heat dissipating feature 22 at its underside to reduce the temperature of the glare shield to reduce outgassing by the glare shield when exposed to extreme temperatures (such as greater than 85 degrees C.). In the illustrated embodiment, the heat dissipating feature 22 comprises a heat sink comprising a plurality of fins or ribs extending from the undersurface of the glare shield (opposite the upper surface that faces or opposes the vehicle windshield) to provide greater surface area for cooling the glare shield. Optionally, airflow at the heat sink may be enhanced (such as via a fan or blower or the like) to enhance the heat dissipation and cooling of the glare shield. For example, a fan may be disposed at a lower part of the camera module to blow air or force airflow across the plurality of fins of the heat sink of the glare shield to enhance cooling of the glare shield.

The heat sink thus draws heat from the upper side of the glare shield to the lower side of the glare shield to reduce the temperature of the glare shield (particularly the upper part of the glare shield at the pocket between the windshield and camera module) and thus reduce fogging at the in-cabin side or surface of the windshield in the forward fields of view of the cameras. The camera module may also include passive or active vents to further cool/ventilate the pocket between the windshield surface and the glare shield and camera housing or cover. For example, the housing or cover of the camera module may have vents at or near the underside of the glare shield to allow for heat dissipation at the heat sink of the glare shield.

Optionally, a heat transfer or heat dissipating element may be in contact with the heat sink of the glare shield and may be exposed at an outer surface of the camera module housing or cover to further draw heat from the glare shield and dissipate the heat into the vehicle cabin and away from the windshield. For example, the heat transfer element may function to draw and conduct heat away from the glare shield and through or around the primary circuit board (disposed in the module housing below the glare shield) to the camera module housing or cover.

The cover is built to hide all the components of the vision system that are disposed at the windshield, but it can be designed (with aesthetic considerations in mind) to act both as a cover and also as a heat exchanger. Although the cover is typically formed of a light-weight plastic, it can be built of a thermally conductive material or with thermally conductive elements or features so as to act as a heat exchanger. The cover can be coupled (mechanically coupled and/or thermally coupled) to the glare shield or it can be coupled (mechanically coupled and/or thermally coupled) to the heat sink at the back of the glare-shield. Since the cover is open to the air inside the vehicle and there is more air movement at the underside or exposed surface of the cover, the cover can draw the heat away from the glare-shield and exchange it with the air inside the vehicle. This concept can be extended further to other components in physical contact to the cover. With more thermal conductivity and more mass, the cover can provide a larger heat exchanger that will keep the components disposed within the cover cooler.

By adding the heat sink to the back or under side of the glare shield and/or to the cover, the rate of heating of the glare shield (when exposed to high temperatures) is reduced and the maximum temperature at the glare shield and windshield (when exposed to high temperatures) is reduced. This reduces the level of outgassing by the glare shield (and other adjacent or nearby plastic components) and thus reduces the haze buildup at the in-cabin side or surface of the vehicle windshield.

Therefore, the present invention provides a windshield-mounted camera module that includes a heat dissipating glare shield for reducing the temperature of the glare shield and thus reducing outgassing of the plastic glare shield when the camera module is exposed to extreme temperatures. The heat dissipating feature may comprise a plurality of fins or ribs extending from an undersurface of the glare shield to provide greater surface area for cooling the glare shield. Optionally, airflow at the heat sink may be enhanced (such as via a fan or blower or the like) to enhance the heat dissipation and cooling of the glare shield.

The forward viewing camera may be disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, which are all hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ™ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular camera module configured to be disposed at an in-cabin side of a windshield of a vehicle, the vehicular camera module comprising:
a housing;
a camera disposed at the housing and, with the vehicular camera module disposed at the in-cabin side of the windshield, having a field of view through the windshield and forward of the vehicle;
wherein the camera comprises an imager having a two dimensional array of photosensing elements;
wherein the camera comprises a lens barrel, the lens barrel accommodating at least one optical lens;
wherein the housing houses a primary circuit board having a processor for processing image data captured by the camera;
a glare shield disposed at the housing;
wherein the glare shield, with the vehicular camera module disposed at the in-cabin side of the windshield, reduces stray light incident at the at least one optical lens of the camera; and
wherein the glare shield comprises a heat dissipating feature at a lower surface of the glare shield opposite an upper surface that faces the vehicle windshield when the vehicular camera module is disposed at the in-cabin side of the windshield.

2. The vehicular camera module of claim 1, wherein the windshield includes a blackout region and a light-transmitting window through the blackout region, and wherein, with the vehicular camera module disposed at the in-cabin side of the windshield, the camera views through the windshield at the light-transmitting window.

3. The vehicular camera module of claim 1, wherein the heat dissipating feature of the glare shield comprises a heat sink.

4. The vehicular camera module of claim 1, wherein the heat dissipating feature of the glare shield comprises a plurality of fins protruding at the lower surface of the glare shield.

5. The vehicular camera module of claim 4, comprising a fan that blows air across the plurality of fins of the glare shield to enhance cooling of the glare shield.

6. The vehicular camera module of claim 1, comprising a fan that blows air across the heat dissipating feature of the glare shield to enhance cooling of the glare shield.

7. The vehicular camera module of claim 1, wherein the glare shield comprises a black plastic material.

8. The vehicular camera module of claim 1, wherein the vehicular camera module, when disposed at the in-cabin side of the windshield, makes intimate contact with the in-cabin side of the windshield at least partially around a periphery of the glare shield.

9. The vehicular camera module of claim 1, comprising a cover element that is, with the vehicular camera module disposed at the in-cabin side of the windshield, disposed at and surrounds the housing and the glare shield at the windshield.

10. The vehicular camera module of claim 9, wherein the cover element is thermally coupled to the glare shield to draw heat from the glare shield.

11. The vehicular camera module of claim 10, wherein the cover element comprises a heat dissipating feature that draws heat from the glare shield and dissipates the drawn heat into the cabin of the vehicle.

12. A vehicular camera module configured to be disposed at an in-cabin side of a windshield of a vehicle, the vehicular camera module comprising:
a housing;
a camera disposed at the housing and, with the vehicular camera module disposed at the in-cabin side of the windshield, having a field of view through the windshield and forward of the vehicle;
wherein the camera comprises an imager having a two dimensional array of photosensing elements;
wherein the camera comprises a lens barrel, the lens barrel accommodating at least one optical lens;
wherein the housing houses a primary circuit board having a processor for processing image data captured by the camera;
a glare shield disposed at the housing;
wherein the glare shield comprises a black plastic material;
wherein the glare shield, with the vehicular camera module disposed at the in-cabin side of the windshield, reduces stray light incident at the at least one optical lens of the camera;
wherein the glare shield comprises a heat dissipating feature at a lower surface of the glare shield opposite an upper surface that faces the vehicle windshield when the vehicular camera module is disposed at the in-cabin side of the windshield; and
wherein the heat dissipating feature of the glare shield comprises a plurality of fins protruding at the lower surface of the glare shield.

13. The vehicular camera module of claim 12, comprising a fan that blows air across the plurality of fins of the glare shield to enhance cooling of the glare shield.

14. The vehicular camera module of claim 12, wherein the vehicular camera module, when disposed at the in-cabin side of the windshield, makes intimate contact with the in-cabin side of the windshield at least partially around a periphery of the glare shield.

15. A vehicular camera module configured to be disposed at an in-cabin side of a windshield of a vehicle, the vehicular camera module comprising:
a housing;
a camera disposed at the housing and, with the vehicular camera module disposed at the in-cabin side of the windshield, having a field of view through the windshield and forward of the vehicle;
wherein the camera comprises an imager having a two dimensional array of photosensing elements;
wherein the camera comprises a lens barrel, the lens barrel accommodating at least one optical lens;
wherein the housing houses a primary circuit board having a processor for processing image data captured by the camera;
a glare shield disposed at the housing;
a cover element that is, with the vehicular camera module disposed at the in-cabin side of the windshield, disposed at and surrounds the housing and the glare shield at the windshield;
wherein the cover element comprises a thermally conductive material;
wherein the glare shield, with the vehicular camera module disposed at the in-cabin side of the windshield, reduces stray light incident at the at least one optical lens of the camera;
wherein the glare shield comprises a heat dissipating feature at a lower surface of the glare shield opposite an upper surface that faces the vehicle windshield when the vehicular camera module is disposed at the in-cabin side of the windshield;
wherein the heat dissipating feature of the glare shield comprises a heat sink; and
wherein the cover element is thermally coupled to the heat sink of the glare shield to draw heat from the glare shield.

16. The vehicular camera module of claim 15, comprising a fan that blows air across the heat sink of the glare shield to enhance cooling of the glare shield.

17. The vehicular camera module of claim 15, wherein the glare shield comprises a black plastic material.

18. The vehicular camera module of claim 15, wherein the vehicular camera module, when disposed at the in-cabin side of the windshield, makes intimate contact with the in-cabin side of the windshield at least partially around a periphery of the glare shield.

19. The vehicular camera module of claim 15, wherein the cover element comprises a heat dissipating feature that draws heat from the heat sink of the glare shield and dissipates the drawn heat into the cabin of the vehicle.

20. The vehicular camera module of claim 19, wherein the heat dissipating feature of the cover element draws heat from the heat sink of the glare shield and through or around the primary circuit board.
